(19) United States
(12) Patent Application Publication
(10) Pub. No.: US 2009/0220143 A1
(43) Pub. Date: Sep. 3, 2009

(54) Method for measuring a shape anomaly on an aircraft structural panel and system therefor

(75) Inventor: Nicolas Fournier, Toulouse (FR)

Correspondence Address: PERMAN & GREEN, 425 POST ROAD, FAIRFIELD, CT, 06824, US

(73) Assignee: AIRBUS FRANCE, Toulouse Cedex 9 (FR)

(21) Appl. No.: 11/997,072

(22) PCT Filed: Jul. 24, 2006
(86) PCT No.: PCT/FR06/50744

§ 371 Date: Sep. 12, 2008

(30) Foreign Application Priority Data
Jul. 26, 2005 (FR) 0552319

(51) Int. Cl. G06K 9/00

(52) U.S. Cl. 382/154

(57) ABSTRACT

The disclosed embodiments concern a method for measuring a shape anomaly on an aircraft structural panel, including the following operations: projecting a target pattern at the site of the anomaly on the panel; producing at least two images of the projected pattern; processing the two images by stereocorrelation to obtain measurements of the anomaly. The disclosed embodiments also concern a system for implementing the method, including: a projected device for projecting a target pattern at the site of the anomaly on the panel; at least two imaging devices for producing each an image of the target pattern; and means for processing the target pattern images.

### CROSS-REFERENCE TO RELATED APPLICATIONS

This application is the National Stage of International Application No. PCT/FR2006/050744, International Filing Date, Jul. 24, 2006, which designated the United States of America, and which international application was published under PCT Article 21(2) as WO Publication No. WO 2007/012781 and which claims priority from French Application No. 05 52319, filed Jul. 26, 2005.

### BACKGROUND

1. Field

The disclosed embodiments relate to a method for measuring a shape anomaly on an aircraft panel. It also relates to a portable system for implementing this method. The system and this method concern anomalies arising out of the manufacture of a panel, the assembling of several panels or an impact on a panel when the aircraft is in service.

The disclosed embodiments find application in the measurement of shape anomalies, especially on panels of large-sized structures such as an aircraft structure.

2. Brief Description

In aeronautical construction, aircraft are traditionally made out of numerous panels joined or assembled to one another. In particular, there are wing panels, fuselage panels, fin panels etc. When several panes are being assembled, it can happen that the geometry of a panel does not exactly correspond to the geometry of the panel or panels with which it has to be assembled. For example, the thickness of a panel may not correspond precisely to the space between other panels allotted to it so that it can be easily inserted therein. In such cases, the operators performing the assembly have two possibilities:

either they return the unsuitable panel to the manufacturing shop so that it can be re-machined, and this may require a relatively lengthy period of time and therefore delays with respect to assembly deadlines;

or they assemble the panels by force, and this may give rise to the deformation of one of the panels.

This results then in shape anomalies or shape irregularities arising out of the assembling of the panels.

It can happen also that one face of the panel is not totally plane at the time of manufacture or that it undergoes impact during transport between the manufacturing plant and the assembly plant.

Shape anomalies may also come about when the aircraft is in service, for example following an impact with a flying creature.

Whatever its cause, a shape anomaly, depending on its location and its size, may have consequences for the safety of the aircraft and/or the aesthetics of the aircraft.

The existence of a shape anomaly is generally spotted with the naked eye by maintenance operators or by the aircraft assembly operators. When an anomaly is spotted, its dimensions must be measured in order to determine the consequences that it might entail and decide on the corrective action to be performed on it.

At present, there are no automatic means to measure the dimensions of such an anomaly, i.e. to measure the geometry of such an anomaly. To date, the anomalies are evaluated manually by the operator. One of the manual techniques of evaluation of a shape anomaly consists in making hot wax flow in the deformed part of the panel, drying this wax until it hardens and then stripping it off in order to obtain an imprint of the anomaly. The dimensions of the anomaly can then be deduced from this imprint. A method such as this is relatively imprecise since the dimensions are obtained from the imprint of the anomaly and not from the anomaly itself. Furthermore, this method is painstaking and difficult to set up, especially when the anomaly is situated in a place that is difficult to reach such as, for example, the upper part of the fuselage or a vertical panel where the molten wax tends to flow along the panel before it dries.

There also exist other known methods for measuring deformations. One of these methods, based on the stereocorrelation of images, is described in D. Garcia and J. J. Orteu “3D déformation measurement using stereocorrelation applied to experimental mechanics”, 10th FIG International Symposium on Deformation Measurements, March 2001, Orange, Calif., USA. Such a method proposes to paint a specific pattern, or target, on a part whose deformation is to be measured. Once the pattern has been painted, this part is made to undergo a deformation, for example by stretching the part or twisting it. The painted pattern gets deformed at the same time as the part. A deformation-measuring system is then used to measure the deformation undergone by the pattern and therefore by the part. The system comprises two CCD type cameras each of which takes a sequence of images of the deformation. More specifically, each CCD camera takes a succession of images of the pattern throughout the period in which the part is being deformed. The sequence of images thus obtained is processed by an image-processing device which rebuilds the image of the deformed part in 3D, using the triangulation principle. To this end, the image-processing device identifies all the points of an image of each sequence and then searches for these points in all the images of the two sequences of images and finally searches for the shifting of these points to determine the deformation of the part.

However, a deformation-measurement system such as this necessitates the painting of a pattern on the part to be measured, and this cannot be done on an aircraft panel, especially when the aircraft is already in service, because this would require that this pattern be subsequently cleaned so that it is not visible on the aircraft. For, each airline generally has a logo and particular decorations that are specific to the company and must be identical from one aircraft to another. The presence of a pattern or target on certain panels of the aircraft would prevent this similarity of the logos and decorations of a same airline company. It is therefore difficult to envisage the painting of a pattern on all aircraft panels having a shape anomaly.

### SUMMARY

The disclosed embodiments are aimed precisely at overcoming the drawbacks of the techniques explained here above. To this end, the disclosed embodiments propose a method for the automatic measurement of a shape anomaly on an aircraft structural panel that necessitates no painting of a pattern on this panel. This method proposes the measurement of the shape of a panel by studying the position of points of a pattern projected on the surface of the panel. In this method, a target pattern is projected on the panel to be verified, two instantaneous images of this projected pattern are taken at different camera angles relative to the panel and then these images are processed by stereocorrelation of images.

More specifically, the disclosed embodiments concern a method for measuring a shape anomaly on a aircraft structural panel characterised in that it comprises the following operations:

projecting a target image at the position of the anomaly on the panel,

producing at least two images of this projected target pattern,

processing these two images by stereo-correlation to obtain measurements of the geometry of the anomaly.

This method may also comprise one or more of the following characteristics:

the images are acquired instantaneously.

the images are transmitted by a transmission link or recorded on a digital recording carrier to be processed remotely.

The disclosed embodiments also relate to a system for implementing this method. This system comprises:

a projection device capable of projecting a pattern on the position of the anomaly, on the panel,

at least two image-taking devices each capable of taking an image of the target pattern, and

a means of processing images of the target pattern projected on the panel.

The system may also comprise one or more of the following characteristics:

the image-taking devices carry out an acquisition of the images instantaneously.

the system comprises a means of synchronisation of the projection device and of the image-taking devices.

the image-taking devices and the projection device are synchronised at a speed lower than or equal to 1/60 seconds.

the image-taking devices are placed so as to form a triangle with the projected pattern.

the system comprises a telemeter.

the image-taking devices and the projection device are mounted on a same holding support.

the telemeter is mounted on the holding support.

the system is portable and autonomous.

the image-processing means is mounted on the holding support and is connected to the image-taking devices.

the image-processing means is placed at a distance and is capable of receiving the images of the projected target pattern by a transmission link or by a digital recording carrier.

the image-taking devices are digital cameras.

the image-taking devices matrix array cameras.

### BRIEF DESCRIPTION OF THE DISCLOSED EMBODIMENTS

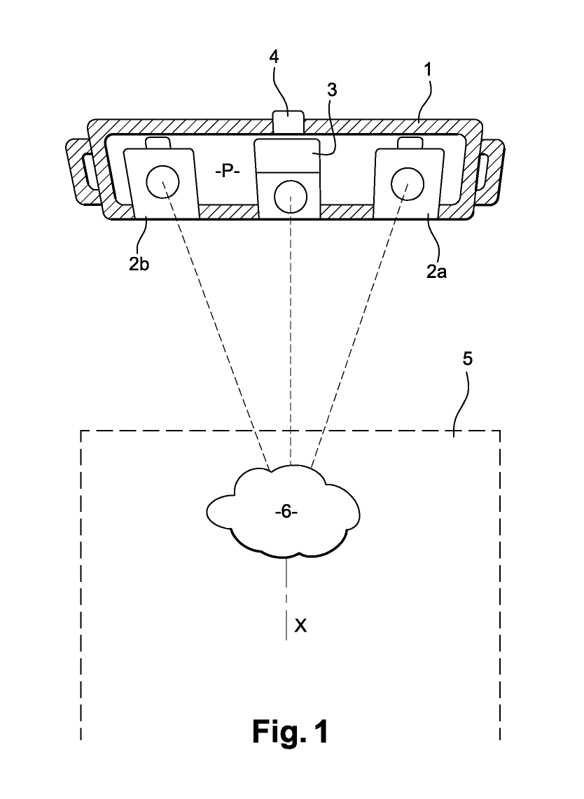

FIG. 1 exemplifies a system for measuring a shape anomaly on an aircraft panel, according to the disclosed embodiments

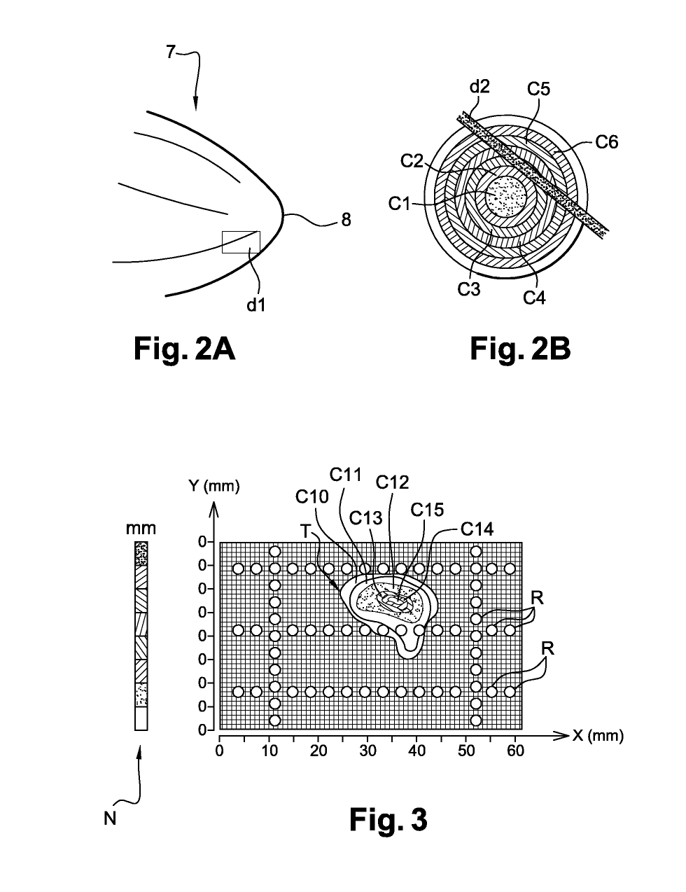

FIGS. 2A and 2B represent an example of an aircraft radome having a shape anomaly and the image of this anomaly obtained with the method of the disclosed embodiments.

FIG. 3 shows an example of a result of a measurement of an anomaly obtained with the method of the disclosed embodiments.

### DETAILED DESCRIPTION OF EMBODIMENT OF THE DISCLOSED EMBODIMENTS

The disclosed embodiments propose a method for the measurement of a shape anomaly on an aircraft panel according to the disclosed embodiments, in which a target pattern is projected on the panel to be processed, i.e. on the aircraft panel showing the anomaly that is to be measured. Images of this target pattern are produced with different camera angles. These images are then processed according to a technique of stereo-correlation. As explained in greater detail here below, the technique of stereo-correlation can be used, by means of triangulation measurements, to rebuild a 3D image of a deformed object from 2D images.

The disclosed embodiments also propose a system for measuring a shape anomaly by which this method can be implemented. The system comprises two image-taking devices to take images of a same object at two different camera angles. According to the disclosed embodiments, the object considered is an aircraft panel comprising a shape anomaly to be measured. The image-taking devices are therefore installed so as to form a triangle with the target pattern projected on the anomaly to be measured.

The measurement system of the disclosed embodiments furthermore comprises a device for projecting a target pattern on the panel to be processed. The target pattern is a speckled pattern consisting of a set of black and white spots of different sizes placed randomly beside one another. According to the disclosed embodiments, this target pattern is projected on the panel to be processed at the position of the anomaly. In other words, it is projected in the zone of the panel comprising the shape anomaly.

The image-taking devices each produce an image of this target pattern projected on the anomaly of the panel. In one embodiment of the disclosed embodiments, the target pattern is projected for a predefined time interval not limited to an instant, i.e. it is projected for a continuous time interval of several seconds or even several minutes. The images of the target pattern projected on the anomaly are taken during this time interval. In a preferred embodiment of the disclosed embodiments, the target pattern projection device is synchronised with the image-taking devices, making it possible to produce the images at the very instant when the target pattern is projected on the panel to be processed. This synchronisation is done at a speed such that the recorded images are sharp, i.e. not fuzzy, without the system being laid on any tripod-type support whatsoever. This synchronisation can be done, for example, with a synchronisation time that is lower than or equal to 1/60 seconds.

To implement this preferred embodiment, the image-taking devices preferably mounted on a same holding support. One example of such a system is shown in FIG. 1. In this example, the holding support 1 is a frame, made out of aluminium for example, to which are fixed the projection device 3 and, on either side of said projection device 3, the image-taking devices 2a and 2b. The projection device 3 is placed in the plane P of the frame, at the centre of the frame, so that the target pattern is projected on the shape anomaly 6 of the panel 5 in the direction of projection X, perpendicular to the plane P of the frame. The image-taking devices 2a and 2b are not in the plane P of the frame so that their image-taking direction is not parallel to the direction of projection X. More specifically, the image-taking directions of these image-taking devices 2a and 2b form a triangle with the plane P of the frame, the vertex of this triangle being formed by the anomaly 6 to be measured.

The position of the image-taking devices in the frame 1, and especially the angle of inclination of the image-taking devices relative to the plane P of the frame, may vary as a function of the extent of the anomaly and the distance at which the holding support is located relative to the panel with the anomaly. In the example of FIG. 1, the system enables a measurement of an anomaly at a distance of the order of 1 m to 1.5 m in a volume of the order of 600×400×200 mm³.

The image-taking devices 2a and 2b may be digital cameras or else matrix array cameras capable of producing instantaneous images of the target pattern projected on the panel to be processed. The term “instantaneous images” is understood to mean two images each produced by a different image-taking device at the same given instant, for example at the instant of projection of the target pattern. These image-taking devices can be used to produce images, for example 1000×1000 pixel images. The acquisition of the images needed for the measurement, called acquisition of the measurement, is done instantaneously.

In the preferred embodiment of the disclosed embodiments, the system comprises a telemeter 4 or any other device by which the distance between the system and the panel to be measured can be easily evaluated. This telemeter 4 may be connected to the image-taking devices 2a and 2b and to the projection device 3, and may be synchronised with these devices, thus offering automatic focusing of these devices to obtain sharp images of the projected target pattern. This telemeter 4 can be mounted also on the frame 1 of the holding support, in the plane P of the frame, for example at the centre of said frame 1.

The measurement system of the disclosed embodiments furthermore comprises a means of processing these images by stereo-correlation. This processing means, not shown in FIG. 1, can be installed at a distance from the holding support 1. In this case, the images may be recorded on an image recording carrier to be processed subsequently, at a distance. This recording carrier may, for example, be a memory card like the ones used in present-day digital cameras, or else a USB stick. The images may also be transmitted to the image-processing means by a Bluetooth wireless link or a WiFi link. Thus, an operator can travel to the airport with the holding support equipped with the projection and image-taking devices to take shots of one more anomalies in aircraft in service, and then carry out the processing of these images subsequently, in office premises at a distance from the airport.

In another variant, the processing means are sufficiently miniaturised to be installed on the holding support. The set of tasks comprising shots and processing can then be done on the spot, in the vicinity of the aircraft concerned, in a minimum time of a few minutes. This variant has the advantage of enabling the operator to recommence the operation in the event of problems with taking shots for example, for example if the shot is not sufficiently sharp or as of the reference points are not sufficiently representative etc.

Regardless of its location, the image-processing means carries out the processing by stereo-correlation of the two unique images of the target pattern, taken at the same instant, at two different camera angles. This processing consists in studying the distribution of the different points of the target pattern in space. Since the points of the target pattern are on the surface of the panel to be measured, the geometry of this panel in the three dimensions of space is thus measured. The shape anomalies of this panel can therefore be deduced therefrom. This image of the geometry of the panel may be obtained in the form of a classic 3D representation along the x, y and z axes. It can also be obtained in the form of a 2D representation along the x and y axes with the dimension z being represented by colours. In this case, the dimension z which corresponds to the depth of the anomaly represented by different colours associated, in a colour chart, with a scale of the depths. The choice of the colours of the colour chart may be defined by the operator from the image-processing means.

FIG. 2A shows an example of a shape anomaly on an aircraft radome 7. FIG. 2B shows an example of an image of this shape anomaly obtained with the method of the disclosed embodiments. More specifically, FIG. 2A is a schematic view of a radome 7 on an aircraft nose. This radome has a longilineal reinforcement d1, shown in a rectangle. This reinforcement d1 constitutes a shape anomaly. FIG. 2B shows the image obtained, with the method of the disclosed embodiments, of this radome would the reinforcement d1. This image shows the general shape of the radome with these different levels of depth each represented by a different colour. The central circular zone c1 corresponds to the tip 8 of the radome 7, having the smallest depth. The circular zones c2, c3 etc correspond to different intervals of depths of the radome. In this FIG. 2B, a discontinuity d can be seen in the circular zones of this image. This discontinuity d2 forms a sort of longilineal bead that crosses the circular zones of the image in an off-centred way. This discontinuity d2 corresponds to the reinforcement d1 on the radome 7 of FIG. 2A.

FIG. 3 shows a schematic example of a 3D image that can be obtained with the method of the disclosed embodiments. This image comprises a grid pattern in two dimensions with measurements indicated in mm on the x and y axes. It also has the representation of the anomaly, namely a spot T with several levels of colours corresponding to the different levels of depth of the anomaly. It also has a colour chart N giving a correspondence between the different colours and the levels of depth. In this example of an image, the two outer colour levels c10 and c11 of the spot represent a depth of the anomaly between 0 and 0.5 mm, the colour level c12 represents a depth between 0.5 and 1 mm, the colour level c13 represents a depth between 1.5 and 2 mm, the colour level c14 a depth between 2.5 and 3 mm and the colour level c15 a depth between 3.5 and 4 mm. This spot T thus shows the shape of the anomaly as well as the depth of the anomaly. From this, the dimensions of the anomaly can be deduced in terms of length as well as width and depth. The depth tolerance obtained with this method is in the range of 50 micrometer for a surface of some square decimeters.

In the example of an image of FIG. 3, the reference points R make it possible to know the exact position of the anomaly on the panel. In this example, the reference marks R correspond to the position of the rivets on the panel.

To obtain these reference points, instantaneous images of the target pattern are produced with a sufficiently wide view of the zone of the panel containing the anomaly so that these images show the environment of the anomaly.

As explained here above, the target pattern projection device and the devices for taking images of said target pattern on the panel to be processed can be mounted in the frame of the holding support. This frame is preferably manufactured from a light material and this makes it possible to have an automatic portable system, easily transportable by the operator in the field. The system may be sufficiently light, for example less than 4 kg, requiring the use of no tripod-type supporting device. The synchronisation of the projection device with the image-taking devices also makes the system easy to handle. The operator can obtain the images directly by holding the system in his hand, thus enabling easy processing of places that are not easy to reach, such as the upper part of the fuselage or the vertical panels of the aircraft.

1- Method for measuring a shape anomaly (6), on a aircraft structural panel (5) characterised in that it comprises the following operations:
the projecting, at the position of the anomaly (6) on the panel (5), of a target pattern constituted by a set of black and white spots, of different sizes, placed randomly beside one another,
the producing of at least two images of this projected target pattern,
the processing of these two images by stereo-correlation to obtain measurements of the geometry of the anomaly.

2- Method according to claim 1, characterized in that the images are acquired instantaneously.

3- Method according to claim 1, characterized in the images are transmitted by a transmission link or recorded on a digital recording carrier to be processed remotely.

4- System for measuring a shape anomaly (6) on an aircraft structural panel (5) characterised in that it comprises:
a projection device (3) capable of projecting, at the position of the anomaly (6), on the panel, a target pattern constituted by a set of black and white spots, of different sizes, placed randomly beside one another,
at least two image-taking devices (2a, 2b) each capable of taking an image of the target pattern, and
a means of processing these images of the target pattern.

5- System according to claim 4, characterized in that the image-taking devices (2a, 2b) carry out an acquisition of the images instantaneously.

6- System according to claim 4, characterized in that it comprises a means of synchronisation of the projection device (3) and of the image-taking devices (2a, 2b).

7- System according to claim 6, characterized in that the image-taking devices and the projection device are synchronised at a speed lower than or equal to 1/60 seconds.

8- System according to claim 4, characterized in that the image-taking devices are placed so as to form a triangle with the projected pattern.

9- System according to claim 4, characterized in that it comprises a telemeter (4).

10- System according to claim 4, characterized in that the image-taking devices and the projection device are mounted on a same holding support (1).

11- System according to claim 10, characterized in that the telemeter (4) is mounted on the holding support (1).

12- System according to claim 1, characterized in that it is portable and autonomous.

13- System according to claim 10, characterized in that the image-processing means is mounted on the holding support (1) and is connected to the image-taking devices.

14- System according to claim 4, characterized in that the image-processing means is placed at a distance and is capable of receiving the images of the projected target pattern by a transmission link or by a digital recording carrier.

15- System according to claim 4, characterized in that the image-taking devices are digital cameras.

16- System according to claim 4, characterized in that the image-taking devices matrix array cameras.
